(19) United States
(12) Patent Application Publication
(10) Pub. No.: US 2015/0112690 A1
(43) Pub. Date: Apr. 23, 2015

(54) LOW POWER ALWAYS-ON VOICE TRIGGER ARCHITECTURE

(71) Applicant: NVIDIA Corporation, Santa Clara, CA (US)

(72) Inventors: Sudeshna Guha, Bangalore (IN); Ravi Bulusu, Hyderabad (IN)

(73) Assignee: NVIDIA Corporation, Santa Clara, CA (US)

(21) Appl. No.: 14/060,367

(22) Filed: Oct. 22, 2013

(51) Int. Cl. G06F 3/16; G10L 15/22

(52) U.S. Cl. CPC G06F 3/167; G10L 15/22
USPC 704/275

(57) ABSTRACT

The description is directed to systems and methods for a low-power, hands-free voice triggering of a main processing complex of a computing system to wake from a suspended state. An always-on voice activity detection module samples output received from a microphone in the computing system and determines whether a portion of the sampled output potentially contains a triggering keyphrase. A special purpose audio processing engine is turned on to confirm the presence of the triggering keyphrase in the sampled output before triggering the main processing complex of the computing system to wake from the suspended state.

### BACKGROUND

Voice commands are now widely used to control computers, and are particularly useful in providing a “hands-free” method of controlling smartphones and other portable computing devices. The availability of hands-free voice control requires that the main processing complex of the device (e.g., the CPU) be active and running an application that interprets voice inputs. When the CPU goes into an idle state, as happens frequently in mobile devices to conserve power, the voice control capability is not available. To wake the device and access the voice command capability, the user normally must press a button or perform some other action with their hands (e.g., a touchscreen gesture), which detracts from the goal of providing as much hands-free operation as possible.

### BRIEF DESCRIPTION OF THE DRAWINGS

FIG. 1 schematically depicts an exemplary computing system configured to determine whether an audio sample contains a triggering keyphrase intended to wake a main processing complex of the computing system from a suspended state.

FIG. 2 schematically depicts example operation of a voice activity detection module operative to determine whether an audio sample contains a preliminary indication of a triggering keyphrase.

FIG. 3 schematically depicts example operation of an audio processing engine operative to determine whether an audio sample contains a confirmatory indication of a triggering keyphrase.

FIG. 4 depicts an exemplary method for voice triggering a computing system to wake from a suspended state.

### DETAILED DESCRIPTION

The description is directed to systems and methods for voice triggering a computing device to wake from a suspended state in which the main processing complex of the device is idle with its voltage supply rail in a low power state. The system uses minimal resources and power to determine whether a user has uttered a triggering keyphrase (e.g., a wakeup command such as “Hello Device”) that signals the user's intention to wake the device up. The components that perform this function may be on different voltage supply rails than the main processing complex so that they can operate at relatively low power levels/consumption and without having to power the main processing complex. The main processing complex is only woken once the other components—which are less complex and consume considerably less power—have confirmed that the triggering keyphrase has been uttered.

In some embodiments, two components that are external to the main processing complex are used to confirm the triggering keyphrase. While the main complex is suspended, an always-on voice activity detection module samples the output from a microphone actively listening to the environment around the device. The always-on voice activity detection module analyzes the sampled output to make an initial determination of whether or not the sampled output contains a preliminary indication of the triggering keyphrase. If there is such a preliminary indication, the system triggers wakeup of a special purpose audio engine, which is an intermediate processing layer that is external to and powered separately from the main processing complex. The special purpose audio engine then performs a processing operation—typically more intensive than that performed by the always-on voice activity detection module—to confirm whether or not the sample from the microphone includes the triggering keyphrase. Upon confirmation, the main processing complex is booted or otherwise woken to perform further processing of user commands.

From the above, it will be appreciated that the main processing complex is not used to confirm whether the user intends to pull the device out of idle and resume active engagement (e.g., voice commanding the device to perform tasks). Instead, the main processing complex and its corresponding supply rail are suspended in a low power state during confirmation.

One might imagine an alternate implementation in which an always-on component makes an initial determination of activity (e.g., the microphone picks up a volume increase), and then wakes the main processing complex to determine whether the triggering keyphrase has been uttered. Such a system would entail costly false positives from a power and performance perspective. Specifically, waking a CPU has significant costs. A wide range of applications, state and settings typically need to be restored, all of which is costly in terms of time and power consumption on the main voltage supply rail. This effort is all wasted in the event that the user did not intend to voice trigger wakeup. Avoiding unnecessary power consumption is generally desirable, and is of particular importance in battery-powered mobile devices.

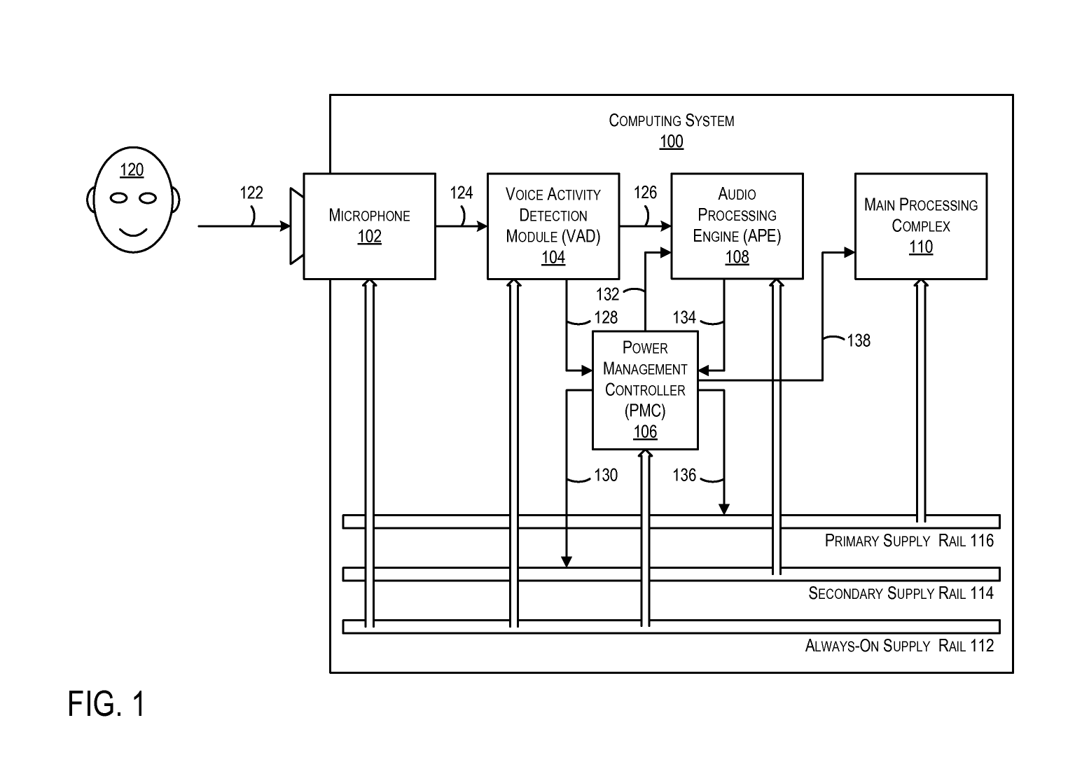

Turning now to the figures, FIG. 1 schematically depicts a computing system 100 which includes a mechanism that can efficiently determine whether a triggering keyphrase has been uttered without requiring the main processing complex 110 to be involved in the determination. Specifically, the determination can occur while the main processing complex is in a suspended state. The suspended state, as described herein, includes deactivating most of the components in the system and leaving only a few active to preserve the state of operating system and to be alert to user input.

The power distribution of the exemplary computing system 100 includes an always-on supply rail 112, secondary supply rail 114 and primary supply rail 116. The always-on supply rail powers a microphone 102, an always-on voice activity detection module (VAD) 104, and a power management controller (PMC) 106. The always-on supply rail remains active and delivers operating power at all times other than when the system is fully powered down, including, in addition to normal operation states, when main processing complex 110 is in a suspended state. In order to maximize the duration of a battery charge, it typically is desirable to keep only minimal logic on the always-on supply rail.

Primary supply rail 116 is selectively activated by power management controller 106 to provide power to main processing complex 110, while secondary supply rail 114 selectively powers special purpose audio processing engine (APE) 108, again under the control of PMC 106. The PMC manages the electrical conditions on each of the supply rails, and may participate in the routing of interrupts to various components in order to wake them from suspended states.

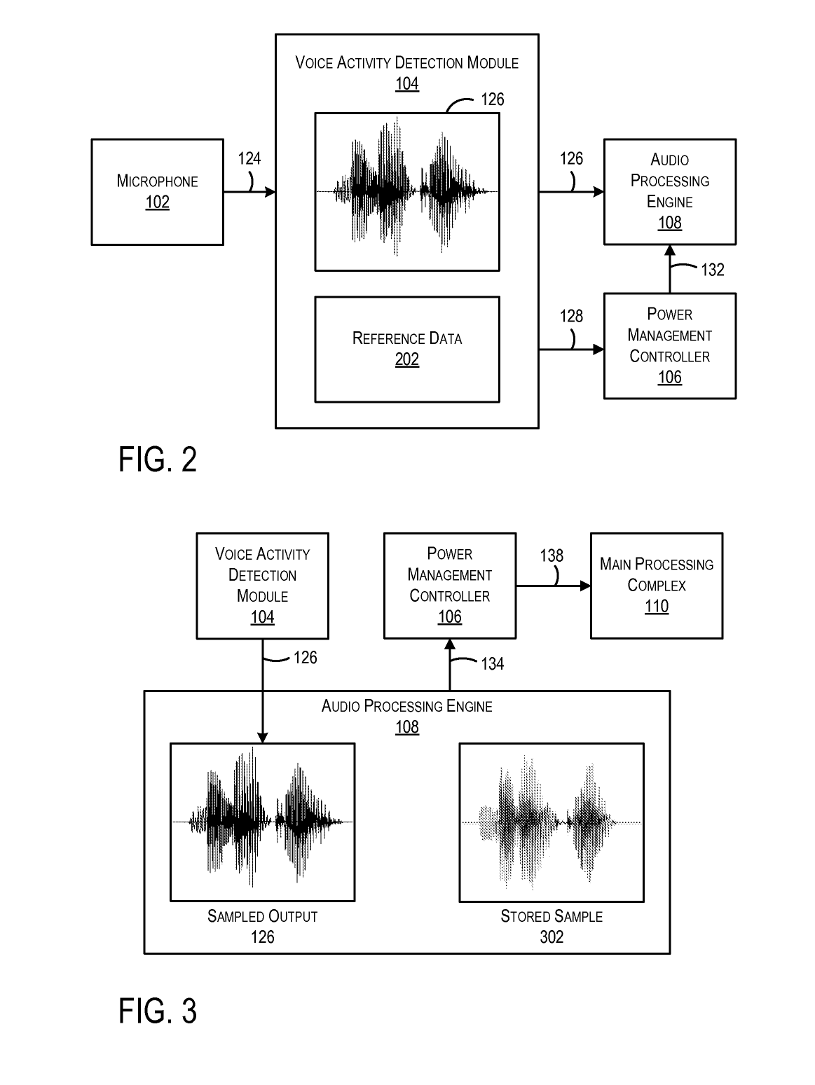

Supply rail 112 powers microphone 102 at all times in order to monitor sounds in the area around computing system 100, which, among other things, may include spoken output 122 from user 120. Output 124 from the microphone is received at VAD 104, which may be configured to continuously sample the microphone output. While the main processing complex 110 and APE 108 are suspended/idle, VAD 104 processes the samples of the recorded output to determine whether they potentially contain the triggering keyphrase. This processing is referred to herein as making a determination of whether the sampled output contains or reflects a “preliminary indication” that the keyphrase has been uttered. A variety of methods may be employed in this preliminary analysis of the microphone output—additional detail and examples will be provided below in connection with FIG. 2.

If the sampled output does preliminarily indicate the triggering keyphrase, a process is initiated to wake and activate APE 108, which then performs a fuller analysis to identify whether the keyphrase was uttered. Specifically, VAD 104 signals PMC 106 (via signal 128), which in turn controls secondary supply rail 114 (via signal 130) to cause the supply rail to deliver the voltage, current, etc. needed to power APE 108. Typically, secondary supply rail 114 is inactive/powered down until the APE functionality is needed in order to conserve power/battery life. The power management controller also may send an interrupt 132 to the audio processing engine in order to trigger wakeup. In addition, VAD 104 provides to APE 108 the sampled output 126 which was found to contain the preliminary keyphrase indication.

As indicated above, APE 108 more thoroughly analyzes the sampled output to confirm whether it contains the triggering keyphrase. This process is referred to herein as determining whether the respective portion of the sampled output contains a confirmatory indication of the triggering keyphrase. Only once the keyphrase is determined to be present is the main processing complex woken up. Specifically, upon making the confirmatory determination, APE 108 signals PMC 106 (via signal 134), which then activates and controls primary supply rail 116 (via signal 136). PMC 106 may also send an interrupt signal 138 to wake the main processing complex 110. The system is then fully awake, such that the main processing complex can then respond to additional voice commands to control various applications, and perform other normal processing operations. In connection with APE 108 triggering wakeup, a confirmation may be provided to signal the user that their utterance worked as intended. For example a tone, beep or other audio output may be provided. Some type of visual output may also be provided on a screen of the device.

From the above, it will be appreciated that the preliminary/confirmatory keyphrase assessment and use of different supply rails enables hands-free voice triggering while efficiently managing power consumption. The main processing complex and primary supply rail are not brought active until presence of the keyphrase is confirmed. In turn, the audio processing engine and its associated supply rail can be held suspended to conserve power until there has been some preliminary indication of the keyphrase. The control regime allows for minimal logic and componentry to be maintained active and connected to the always-on supply rail.

FIG. 2 depicts in more detail the operation of voice activity detection module 104 that is used to preliminarily identify whether the triggering keyphrase has been spoken. As discussed above, microphone 102 provides recorded output 124 to VAD 104. The VAD continuously samples the recorded output; an example sample is shown at 126. If sample 126 contains a preliminary indication of the keyphrase, (i) PMC 106 is alerted via signal 128; (ii) PMC 106 controls secondary supply rail 114 (FIG. 1) to increase activity and deliver needed power to APE 108; (iii) PMC 106 routes an interrupt 132 to APE 108; and (iv) sampled output 126 is provided to APE 108 for further analysis. It should be understood that these signals/triggers are exemplary; a variety of other methods may be employed to activate APE 108 in response to a preliminary indication of the keyphrase.

The determination of whether to trigger APE 108 can be performed in a number of different ways. In one example, VAD 104 affirmatively identifies the preliminary indication of the keyphrase when the volume of a portion of sampled output 126 exceeds a threshold. In another example, sampled output is assessed to discern between vocalization and non-vocalization noise—human speech has qualities that are different from other sounds. A further alternative is to analyze the sampled output to determine whether any portion of it matches or approximates a characteristic of the triggering keyphrase. For example, the sample might contain a series of volume peaks that occur in a cadence/timing similar to that of the keyphrase. Still further, analysis can be performed to assess whether the sampled output matches a characteristic of a voice of an authorized user of the device. These example methods may be employed individually or, in some cases, combined.

Analysis within VAD 104 may be assisted via comparisons with reference data 202. In particular, reference data may contain a volume threshold, data associated with characteristics of the keyphrase, data associated with the voice of an authorized user, etc. Though depicted as being stored within VAD 104, it will be appreciated that the reference data may be stored elsewhere.

The depicted system may be configured to increase the accuracy of the VAD analysis over time to reduce false positives. For example, adaptive feedback learning may be used in connection with the analysis performed by APE 108. If a certain waveform consistently results in the APE not finding the keyphrase, the VAD can respond in the future to that waveform by not triggering wakeup of the APE. Over time, this would increase the energy efficiency of the system by avoiding the unnecessary activation and powering of the APE.

FIG. 3 depicts in more detail the operation of APE 108 to confirm the presence of the triggering keyphrase. As discussed above, once a preliminary indication of the keyphrase is found, VAD 104 provides the relevant sample data (e.g., sampled output 126) to the VAD for further analysis. APE 108 then analyzes the sample to determine whether the sample contains a confirmatory indication of the keyphrase (e.g., determines that characteristics of the sample identically or closely match characteristics of the keyphrase). Once confirmation is found, APE may alert PMC 106 (e.g., via signal 134), and an interrupt 138 may be routed to main processing complex 110 to trigger its wakeup. In connection with this, the PMC 106 manages primary supply rail 116 (FIG. 1) to satisfy the energy needs of the main processing complex 110.

If the APE determines that the keyphrase was not uttered (i.e., via analysis of sampled output 126, then the system returns the APE and its associated secondary supply 114 (FIG. 1) to the suspended mode and awaits further subsequent triggering from VAD 104. Shutting down APE 108 may also include flushing the sampled output from a storage buffer.

A variety of methods may be used to determine whether sampled output 126 contains a confirmatory indication of the keyphrase (e.g., a high level of certainty that the keyphrase was uttered). In some cases, the analysis may include comparing sampled output 126 to a stored sample 302. For example, waveforms may be compared to identify similarities. A score might be generated to quantify the degree of similarity, with confirmation being found when the score exceeds a threshold. Additionally, the stored sample may refer to a dictionary-based record that may be compared to the sampled output using voice recognition techniques.

Regarding the triggering keyphrase, it may include any vocalized sound or series of sounds that may or may not have meaning. The keyphrase may be programmable by the user to provide a custom keyphrase.

Similar to the analysis at VAD 104, the analysis of the audio processing engine may improve over time via use of feedback. For example, it might be determined through various methods that a particular vocalization wakes the main processing complex in error, i.e., when the user was not intending a wakeup. Processing within the APE would then be adjusted to correct the false positive.

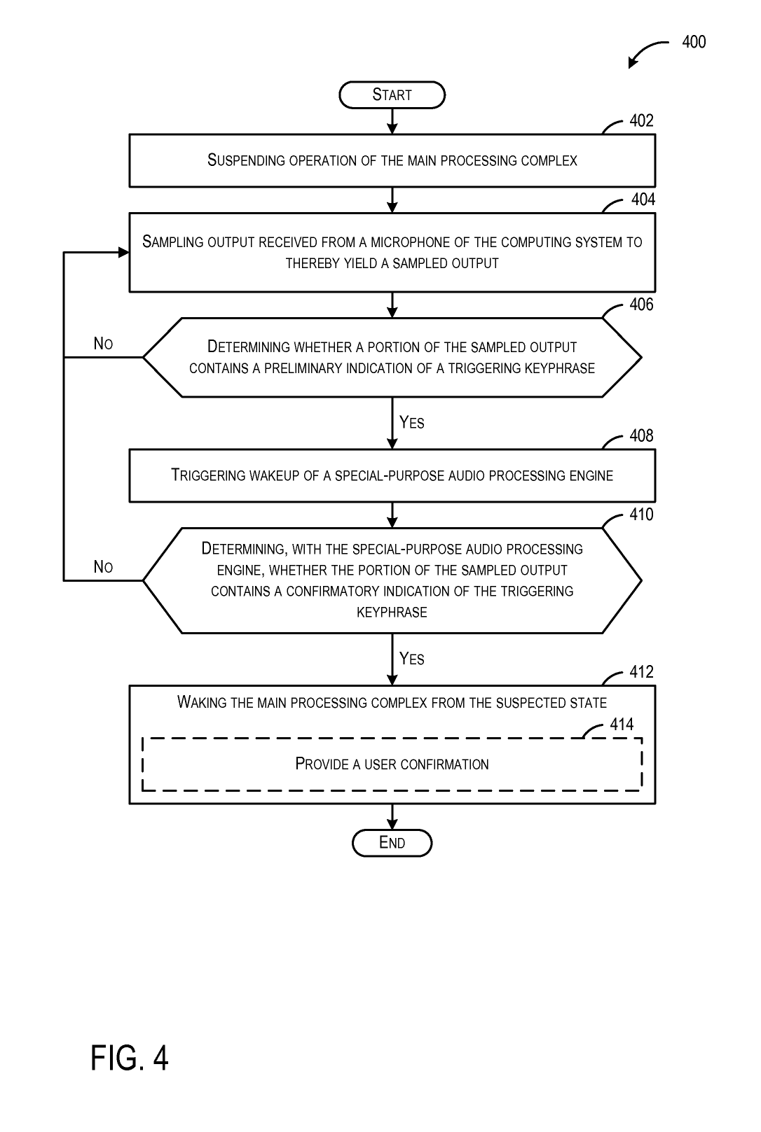

Turning now to FIG. 4, the figure depicts an exemplary method 400 for hands-free voice triggering a main processing complex of a computing system to wake from a suspended state. As shown at 402, the method contemplates the main processing complex of the computing system starting in a suspended state. As such the method starts with suspending operation of the main processing complex. As in the examples above, the computing system includes a microphone that is powered and actively listening to the environment in the vicinity of the computing system, even when the main processing complex and other components are in a suspended state. At 404 the method includes sampling output received from the microphone to thereby yield a sampled output. The sampled output is then processed to make an initial determination as to whether it potentially includes a user-uttered triggering keyphrase that is used to wake the main processing complex. Specifically, at 406, the method includes determining whether a portion of the sampled output contains a preliminary indication of the triggering keyphrase. Examples of how this determination may be made are discussed above. If there is no such preliminary indication, the system continues to sample the microphone output and assess it for the presence of the preliminary keyphrase indication (404 and 406).

If step 406 is affirmative (i.e., there is a preliminary indication of the triggering keyphrase), then a special-purpose audio processing engine may be triggered to awake, as shown at 408. As discussed above, the APE is specifically configured to perform additional processing on the sampled output to confirm that the triggering keyphrase was uttered. Specifically, as shown at 410, the method includes determining whether the respective portion of the sampled output contains a confirmatory indication of the triggering keyphrase. If not, the APE is powered down and the system returns to the sampling and preliminary indication assessment shown at 404 and 406. If step 410 tests in the affirmative, then the main processing complex is triggered to awake, as shown at 412. At this point the user may be provided with a confirmation (414) that their utterance has in fact triggered the device to awake. As discussed above, the confirmation may include and audio and/or visual confirmation from the device.

The examples discussed above contemplate a spoken word keyphrase. It will be appreciated however, that any sound may be employed as a predetermined trigger to awake the device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. In a computing system with a main processing complex, a method for hands-free voice triggering the main processing complex to wake from a suspended state, comprising:
suspending operation of the main processing complex;
sampling output received from a microphone of the computing system to thereby yield a sampled output;
determining whether a portion of the sampled output contains a preliminary indication of a triggering keyphrase;
triggering, if the portion of the sampled output does contain the preliminary indication, wakeup of a special-purpose audio processing engine;
determining, with the special-purpose audio processing engine, whether the portion of the sampled output contains a confirmatory indication of the triggering keyphrase; and
waking the main processing complex from the suspended state if the sampled output contains the confirmatory indication of the triggering keyphrase.

2. The method of claim 1, where determining whether the portion of the sampled output contains the preliminary indication includes comparing the portion of the sampled output to a volume threshold.

3. The method of claim 1, where determining whether the portion of the sampled output contains the preliminary indication includes discerning between vocalization and non-vocalization noise.

4. The method of claim 1, where determining whether the portion of the sampled output contains the preliminary indication includes determining whether the portion matches a characteristic of the triggering keyphrase.

5. The method of claim 1, where determining whether the portion of the sampled output contains the preliminary indication includes determining whether the portion matches a characteristic of a voice of an authorized user.

6. The method of claim 1, further comprising, after waking the main processing complex, using the main processing complex to analyze and substantively respond to voice commands.

7. The method of claim 1, where the main processing complex and special-purpose audio processing engine are on different supply rails.

8. The method of claim 1, where the sampling of microphone output and the determining whether the portion of the sampled output contains the preliminary indication are performed by an always-on voice detection module.

9. The method of claim 8, where the always-on voice detection module, special-purpose audio processing engine, and main processing complex are all on different supply rails.

10. The method of claim 1, further comprising providing a user confirmation in response to determining that the portion of the sampled output does contain the confirmatory indication.

11. A computing system configured to wake from a suspended state in response to an audio trigger, comprising:
a main processing complex;
a microphone;
an always-on voice detection module configured to (i) sample output from the microphone and thereby obtain a sampled output, and (ii) determine whether a portion of the sampled output contains a preliminary indication of a triggering keyphrase; and
a special-purpose audio processing engine configured to (i) wake up in response to the always-on voice detection module determining that the portion of the sampled output contains the preliminary indication, and (ii) determine whether the portion of the sampled output contains a confirmatory indication of the triggering keyphrase, where the main processing complex is configured to wake from a suspended state if the portion of the sampled output contains the confirmatory indication of the triggering keyphrase.

12. The computing system of claim 11, where the always-on voice detection module is configured to determine whether the portion of the sampled output contains the preliminary indication by comparing the portion of the sampled output to a volume threshold.

13. The computing system of claim 11, where the always-on voice detection module is configured to determine whether the portion of the sampled output contains the preliminary indication by discerning between vocalization and non-vocalization noise.

14. The computing system of claim 11, where the always-on voice detection module is configured to determine whether the portion of the sampled output contains the preliminary indication by determining whether the portion matches a characteristic of the triggering keyphrase.

15. The computing system of claim 11, where the always-on voice detection module is configured to determine whether the portion of the sampled output contains the preliminary indication by determining whether the portion matches a characteristic of a voice of an authorized user.

16. The computing system of claim 11, where the main processing complex, special-purpose audio processing engine, and always-on voice detection module are on different supply rails.

17. In a computing system with a main processing complex on a first supply rail, a special-purpose audio processing engine on a second supply rail, and an always-on voice detection module on a third supply rail, a method for hands-free voice triggering the main processing complex to wake from a suspended state, comprising:
suspending operation of the main processing complex;
sampling, with the always-on voice detection module, output received from a microphone of the computing system to thereby yield a sampled output;
determining, with the always-on voice detection module, whether a portion of the sampled output contains a preliminary indication of a triggering keyphrase;
triggering, if the portion of the sampled output does contain the preliminary indication, wakeup of the special-purpose audio processing engine;
determining, with the special-purpose audio processing engine, whether the portion of the sampled output contains a confirmatory indication of the triggering keyphrase; and
waking the main processing complex from the suspended state if the sampled output contains the confirmatory indication of the triggering keyphrase.

18. The method of claim 17, further comprising, after waking the main processing complex, using the main processing complex to analyze and substantively respond to voice commands.

19. The method of claim 17, further comprising providing a user confirmation in response to determining that the portion of the sampled output does contain the confirmatory indication.

20. The method of claim 17, where the triggering keyphrase is programmable by a user.
